(19) United States
(12) Patent Application Publication
(10) Pub. No.: US 2024/0010410 A1
(43) Pub. Date: Jan. 11, 2024

(54) PLASTIC CONTAINER HAVING A RIGIDIFIED SINUSOIDAL CHANNEL STRUCTURE

(71) Applicant: CO2Pac Limited, Auckland (NZ)

(72) Inventors: David Murray MELROSE, Mt. Eden, Auckland (NZ); Campbell John MELROSE-ALLEN, Mt. Eden, Auckland (NZ)

(73) Assignee: CO2Pac Limited, Auckland (NZ)

(21) Appl. No.: 18/347,084

(22) Filed: Jul. 5, 2023

Related U.S. Application Data
(60) Provisional application No. 63/358,391, filed on Jul. 5, 2022.

(51) Int. Cl. B65D 79/00; B65D 1/02; B65D 1/44; B65C 3/06; B67B 3/20; B67C 3/22

(52) U.S. Cl. CPC B65D 79/0084; B65D 1/0223; B65D 1/44; B65C 3/06; B67B 3/20; B67C 3/22; B65D 2501/0036

(57) ABSTRACT

A container having an inverted active cage generally includes an enclosed base portion, a body portion extending upwardly from the base portion, and a top portion with a finish extending upwardly from the body portion. The body portion further includes a central longitudinal axis, a periphery, a plurality of rigidified and non-active surfaces, and a network of pillars or channels. Unlike the prior art, each of the plurality of non-active surfaces is outwardly displaced with respect to the longitudinal axis, while each of the network of pillars or channels is inwardly displaced with respect to the longitudinal axis. The plurality of rigidified or non-active surfaces, together with the network of rigidified channels or pillars, are spaced about the periphery of the container in order to accommodate vacuum-induced volumetric shrinkage of the container resulting from a hot-filling, capping and cooling thereof.

### CROSS-REFERENCE TO RELATED APPLICATION

The present application claims the benefit of priority to U.S. Provisional Application Ser. No. 63/358,391, filed on Jul. 5, 2022, which is incorporated herein by reference in its entirety.

### BACKGROUND OF THE INVENTION

### 1. Field of the Invention

The present invention generally relates to a pressure-adjustable container, and more particularly to such containers that are typically made of polyester and are capable of being filled with hot liquid. It also relates to an improved sidewall construction for such containers.

### 2. Statement of the Prior Art

“Hot-fill” applications impose significant and complex mechanical stress on the structure of a plastic container due to thermal stress, hydraulic pressure upon filling and immediately after capping the container, and vacuum pressure as the fluid cools.

Thermal stress is firstly applied to the walls of the container upon introduction of hot fluid. The hot fluid causes the container walls to first soften and then shrink unevenly, causing distortion of the container. The plastic material (e.g., polyester) must, therefore, be heat-treated to induce molecular changes resulting in a container that exhibits thermal stability.

The thermal stress varies according to the filling method used. For example, typical ‘neck support’ fillers where the container is held by the neck-support transfer ring during the filling period may apply different thermal stress to a container, prior to capping or sealing the container, than typical ‘base-support’ fillers, where the container is supported by the base during the filling cycle prior to capping and sealing. The variable thermal stress applied to the containers between such filling methods may induce a corresponding variation in the height of the bottles during processing of the container unless the container sidewall structures are specifically designed to resist or regulate these variable thermal stresses as described in the present invention. As container sidewalls are light-weighted, this variable stress becomes even more apparent and there is a need for more complex sidewall structures to resist and to regulate the variable filling stresses.

Pressure and stress also act upon the sidewalls of a heat resistant container during the filling process, and for a significant period of time thereafter. When the container is filled with hot fluid and sealed, there is an initial and variable thermal stress on the container as described above. There is often a variable top load applied to the containers during the filling cycle to further complicate the stresses being applied to the containers. In the case of typical neck support fillers there may be little, or no, vertical downward or compressive force applied to the sidewalls during the filling period prior to capping. The container hangs by the neck support ring and with the introduction of the heated fluid there is a hydrostatic pressure applied to the sidewalls of the container exerted by the weight of the heated fluid—due to the force of gravity within the open container prior to sealing or capping.

If the filling temperature is above approximately 75 degrees Celsius, the hot fluid also causes the plastic in the sidewalls to enter a ‘glass transition state’ and the sidewalls become soft, malleable, and are readily subjected to deformation in the presence of both downward or radial forces. Such downward and radial forces are exerted on the container during filling, and in variable ways according to the fill method. Downward internal force from the weight of hot liquid in a container may cause the container to expand in length along the longitudinal aspect. In detail, all structures within the sidewall are particularly vulnerable to deformation, either in the radial or transverse planes, and also in the longitudinal direction.

The choice of structures to utilize in the sidewalls of containers is therefore compromised by the ability of the structures to withstand the variable compressive and expansive stresses acting upon the structures in different directions. The expansion forces applied to the hot container walls during a typical neck support filler may be further amplified if the filler does not properly ‘vent’ the neck opening during the filling cycle. For example, if the hot liquid contents are introduced under any effective hydraulic loading pressure, such as might occur when the neck is closed off to an extent during filling—causing a rise in internal pressure within the container during the filling cycle. The internal hydraulic pressure will also be applied to the inside of the container in addition to the hydrostatic pressure being applied by the simple weight of the product itself. This increase in internal force against the base and sidewall while the container is temporarily exposed to hydraulic pressure causes further expansion stresses being applied to the walls of the container in both the outward radial and outward longitudinal extents.

These forces can result in reasonably significant ‘stretching’ of the container, resulting in a container that is no longer a correct size or height. If incorrect height containers are subsequently packed together with correctly-sized containers then significant problems can occur, for example in palletization of mixed sized containers, where the different load heights may become very unstable and dangerous in a typical warehouse situation.

Further problems could arise in a number of situations if heights of containers are not controlled properly, for example in container vending machines, where the heights of the containers must be kept the same, or within very tight tolerances, or wrong sized containers may not vend properly or become ‘stuck’ in the vending machine.

Alternatively, a container may be filled by a typical base support filler that may in fact apply significantly different forces during the hot side of the filling cycle than are exerted by a neck support filler. When being filled in this alternative manner the container may instead have a downward and compressive top load applied directly to the neck of the container during the filling period. This downward compressive force is not countered by the support mechanism found in a neck support filler and may result in load being applied directly down the container sidewalls. The force is contained by the standing ring of the container and directed across the transverse base. These forces are very different to the internal and expansionary forces encountered in the neck support filler described above. If a container is effectively mechanically compressed in height under base support fill, or if any downward load is applied to the neck finish during the fill cycle and the base is supported (as opposed to hanging fee in the air as encountered in a neck support filler), then compressive forces may be applied to the sidewalls of the container causing a reduction in height of the container simultaneously with the sidewalls exceeding glass transition temperature (Tg) and this may result in a ‘forced’ shortening or lowering in height of the sidewalls.

This lowering in height potential by base support fillers, when compared to an increase in height potential by neck support fillers, results in compromises in height differential between containers manufactured to the same specifications off the same blow-molder, but then processed on the different filling systems. There may be large variations in height once hot filled and processed on a base support system, where containers are shortened, to containers hot filled and processed on a neck support or hang system. On a base support system the container height may be forced downward resulting in a decrease in height, while the same containers processed on a neck hang system may alternatively result in an increase in height.

The application of such variable longitudinal forces, depending on the fill methods, causes either longitudinal stretching or longitudinal compressing of the container. Such height variations and stresses are significantly affected by the thickness of the plastic material. The lighter or thinner the material, then the worse the stretching or compressing in height. This is a severe problem for an industry committed to light-weighting plastic bottles to reduce overall quantities of plastic being processed. Additionally, any increase in post consumer resin (PCR), or recycled PET (rPet) causes even further increased problems. The mechanical strength of the container sidewalls and base may be significantly reduced, causing even further stretching and/or compressing. Importantly, increasing PCR has particular impact on moveable bases compared to traditional ‘hot fill’ bases that are internally recessed to a strong degree and are composed of thick slugs of plastic.

Many hot filled beverage containers require the addition of various ribbings or strengthening structures. These are typically deployed in the container to increase container resistance to vacuum forces during the period of distribution to consumers after labelling of the containers. The ribs and strengthening structures also provide a degree of ‘structure’ or ‘strength’ in a consumer experience. It is desirable for a consumer to feel the strength in a container when handling and drinking from the container. This is particularly important as containers are continuously made thinner in thickness and lighter in sidewall weight. The lighter or thinner the sidewalls in a container, the weaker the container structure becomes in the presence of either vacuum or manipulation by a consumer.

Very light weight bottles, without sufficient resistance within the sidewall structures, may become very unstable on the fill line during processing. Such light-weight bottles without sufficient rigidity structures may also experience significant problems in distribution due to not having enough top load characteristics. During distribution pallet loads of containers may be packed upon each other, so it is very important that filled containers hold sufficient ‘top load’ ability. Further, following purchase by the consumer, it is important for the container to feel strong and ‘structured’ with a desirable ‘feel’ in the consumer hands.

In the case of containers that are not configured properly, they may become prone to instant ‘overflow’ when opened by a consumer due to the sidewalls collapsing as the consumer grips the container and the contents ‘gush’ out as soon as the cap is removed. Thus, there is a need for ever more complex ribbings and strengthening structures as containers are light-weighted and/or different filling technologies are utilized on containers of the same design specifications.

The need for even better rigidifying or stabilizing structures on the sidewall of a container becomes even more important as increased use of PCR is utilized. Recycled PET containers may include a higher copolymer content. But hot-fill containers with rPET content may typically lower the crystallinity of the hot-fill container, as recycled content effectively increases the copolymer content, thereby suppressing crystallinity in bottle walls and base. This may create challenges during hot filling because the crystallinity levels help ensure that the container maintains its shape during the elevated filling temperatures of a hot-fill process. If crystallinity levels are suppressed, the resulting container may not be as strong as desired or may deform at the elevated temperatures required for hot filling. For example, increased recycled content may undesirably reduce sidewall or base stiffness or rigidity. Accordingly, containers with sidewalls having a higher recycled content—and corresponding lower crystallinity—may be more prone to distortion.

Several problems exist with the addition of horizontal ribbings, however, particularly in the presence of light-weighting and/or increased use of PCR within material compositions. Container designs prone to stretching will stretch even more, and container designs prone to compression (lack of top load) will alternatively compress even more. This results in much greater differentials between container heights blow-molded to the same specifications.

Once the container has been filled by either a neck support or base support filling system, the height of lightweight containers having even 20% PCR content, the heights of the containers may be variably compromised due to weakening of the horizontal ribs in the sidewalls and increased base roll-out in the base. Subsequently during processing, the container of either filling system is then passed to a capping unit and sealed, and it is then placed on the conveyor belt of the filling line. Additional downward force may be applied during the capping phase that further compresses a container in height briefly unless there is 100% neck support available while the container is hanging during this time.

Following capping, the sealed liquid contents are then used to sterilize the internal surfaces of the container and cap. This process generally requires the closed container to be inverted or laid horizontally on its side for a brief period, followed by a short holding time of approximately 1 further minute prior to placing the container in a cooling unit that begins to lower the temperature of the sidewalls first, followed by a gradual reduction in internal container temperature.

This period on the ‘hot side’ of the processing cycle is generally shared in execution technique between both base support and neck support systems, with both systems utilizing a base support system during conveyor transport. However, during this post-capping period further internal force is applied to the hot sidewalls of the container, generally evenly shared in force between the systems. There is a period of sustained pneumatic pressure created within the headspace of the sealed container, as a result of the air in the headspace expanding under the heat of the contents, but being restrained by the seal or cap. This pneumatic pressure contributes to a rise in internal pressure that results in an expansionary force longitudinally within the container. This force may further stretch the container longitudinally.

Another force is also added to this pneumatic pressure. The plastic sidewalls generally attempt to contract radially inwardly and return by memory to their original preform size and shape. This ‘contraction’ or shrinking of the sidewalls is prevented by the presence of the sealed container capping the liquid. The hot liquid during this period of processing is largely incompressible until it is cooled and brought down in temperature, whereby the liquid may then contract in size. The sidewalls therefore exert a hydraulic pressure against the headspace within the container. This hydraulic pressure against the headspace caused by the hot contracting sidewalls, being above Tg and therefore moveable, compresses the headspace contributing to a further rise in internal pressure inside the hot and capped container.

The combination of hydraulic pressure acting to increase the headspace pressure, and the thermo-pneumatic pressure within the headspace acting to compress the headspace causes an overall increase in the headspace pressure. This period of increased hydraulic pressure against the hot container sidewalls continues through to entry of the container in to the cooling tunnel. All structures in the container may therefore be deformed both radially and longitudinally during the hot-side of the processing cycle. Any change in shape of the container structures, and in particular any height change, is made possible only while the container is above Tg in temperature. Typically the containers are filled to approximately 85 degrees C., and this causes much stress on the containers during this time, and is made worse by any light-weighting to the sidewalls, and any addition of PCR content.

Once the container enters the cooling tunnel, the sidewalls are quickly brought down to under Tg, or under about 75 degrees C., and no further significant plastic deformation will occur.

Plastic deformation will be partly recoverable, and partly non-recoverable. The height changes and sidewall deformations encountered on the hot-side of processing will then be ‘locked’ into the container as it enters the cooling tunnel and the plastic is brought down to below approx.

Accordingly, there is a need for a hot-fill container that has a high recycled content and is fully recyclable. Further, there is a need for a hot-fill container having sidewall structures with these recycle characteristics that have increased resistance to longitudinal expansion forces and/or increased resistance to longitudinal compression forces and can be made light weight and have good strength characteristics.

There is a need for a hot-fill container having base structures with these recycle characteristics that have increased resistance to longitudinal expansion forces that can be made light weight and have good strength characteristics and acceptable longitudinal compressive characteristics during hot-filling.

As discussed in more detail below, this can allow for production of thinner and lighter weight bottles that maintain the same strength as conventional bottles (e.g., 100% PET bottles) or can allow for increased bottle strength without increasing thickness or weight of the bottle.

To achieve this goal, there is a great need to utilize ever more complex structures on the sidewall of hot fill containers to cope with the complex filling technologies utilized today, the decreasing weights of the containers enabled by advanced hot fill technologies such as Active Base® technologies, and increasing requirements for the use of increasing amounts of PCR in the container.

Sidewall structures in particular, when combined with Active Base or Aseptic Capping Technologies® and made lightweight, with increased amounts of PCR, must both withstand and regulate the opposite forces of both compression and expansion during the hot-side filling cycle, the vacuum forces during the cold side of the filling cycle during the cooling tunnel and prior to compensations available within certain base structures, either by self-activating under vacuum pressure, or by mechanical and/or aseptic capping forces. Additional to this, the complexity required of sidewall structures extends to control of the container during the overall filling cycle, control of top load situations whereby sidewalls must withstand additional forces during distribution.

A further requirement of high-speed filling lines is related to the container surfaces at the precise time of labelling. Once the container exits the cooling tunnel it is conveyed to the labeller for application of a label. Typically this will take place before the container has reduced in temperature to ambient temperature, but will take place under a vacuum induced within the container, with the container at around 30-40 degrees C. internal temperature.

Typically, containers have vacuum deformation zones to accommodate vacuum pressure that would otherwise distort and deform the sidewalls. Typical vacuum panels are found in much prior art, and novel deformation zones are disclosed in U.S. Pat. No. 6,779,673 by the present inventor that also discloses ‘inverted cage’ structures surrounding a plurality of ‘active surfaces.’ A problem may exist, however, with deformation zones that are deformed inwardly under vacuum as the container is presented for label application. The speed at which the label may be applied is limited to the available non-deformed surface area. Put simply, there is a need for a container having minimal deformation zones that deform radially inwardly in order to provide for higher speed label application. However, without vacuum panels or deformation zones, increased stress from vacuum pressure is applied to the container and there is therefore a corresponding need for increased use of structures specifically aimed at imparting greater hoop strength within the container to withstand vacuum force and provide for clean surfaces to be presented to the labeller at the correct timing during processing.

There is therefore a need for a container having decreased inward deformation zones in the sidewall, but increased rigidifying structures in the sidewall. However, the increased sidewall structures must provide increased top load characteristics and resistance to downward longitudinal force. The increased sidewall structures must also provide acceptable resistance to longitudinal stretching forces during the hot-filling cycle.

In addition to the need for strengthening a container against both thermal and vacuum stress during filling, there is a need to allow for an initial hydraulic pressure and increased internal pressure that is placed upon a container when hot liquid is first introduced and then followed by capping. This causes stress to be placed on the container sidewall. There is a forced outward movement of the heat panels, which can result in a barreling of the container.

Accordingly, there is a need for a hot-fill container that has a high recycled content and is fully recyclable. Further, there is a need for a hot-fill container and base structures with these recycle characteristics that have increased resistance to distortion during hot filling.

### SUMMARY OF THE INVENTION

As discussed in more detail below, the present invention can allow for production of thinner and lighter weight bottles that maintain the same strength as conventional bottles (e.g., 100% virgin PET bottles) or can allow for increased bottle strength without increasing thickness or weight of the bottle and contain more than 20% PCR.

Elastic modulus measures a material's resistance to being deformed elastically when stress is applied. A higher elastic modulus corresponds to a material that is stiffer and thus more resistant to deformation.

Compared to containers made with 100% virgin PET, containers having increased recycled content or PCR generally are more prone to distortion. For example, high recycled content may result in lower crystallinity of the container, which in turn decreases the strength of the container. However, the method of manufacturing a base or structures provided in the sidewalls as according to the present invention improves the strength and ‘effective’ crystallinity of a container having an increased recycled content of plastic.

As discussed below, strength of the container may be assessed by measuring the vacuum load on a finished container, or measuring the top-load capacity by compressing the finished container—either while vented and hot-filled, or following filling with a liquid and capping. Additional measures of the strength of a container may be assessed by measuring the elongation or stretch of a container—again either while vented and hot-filled, or following filling with a liquid and capping. There is a generally accepted relationship between rigidity and percentage of recycled content for typical containers. Typically, as the percentage of recycled content increases, the rigidity or various strength characteristics of the container decreases. Configuring the sidewalls and bases of containers according to the present invention illustrates the improved relationship between rigidity and percentage of recycled content for containers disclosed herein.

During blow-molding, heat may be added to the bottle wall, which can increase crystallinity of the polymer composition. In some embodiments, during blow-molding heat is added until the crystallinity is at least 30% at any given point on the container. After blow-molding, the container may be filled. In some embodiments the container is filled using a hot-fill process, however the configurations disclosed impart greater strength to the container that benefits cold filled or aseptic process filling also. In some embodiments, the container is filled with a beverage at a temperature from 80 degrees Celsius to 100 degrees Celsius (e.g., from degrees Celsius to 95 degrees Celsius, from 85 degrees Celsius to 90 degrees Celsius). In some embodiments, the container is filled with a beverage at a temperature of greater than or equal to 85 degrees Celsius (e.g., greater than or equal to 90 degrees Celsius). After filling, the container may be capped and the contents cooled.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and form part of the specification, illustrate various, non-limiting embodiments of the present invention. In the drawings, like reference numbers indicate identical or functionally similar elements.

FIG. 1 illustrates an example of a beverage container (“Bottle A”).

FIG. 2 illustrates the effect of overpressure on Bottle A during filling the container while the container is hanging by the neck in a neck hang fill system.

FIG. 3 illustrates an example of a beverage container (“Bottle B”) according to some aspects of the present invention.

FIG. 4 illustrates the effect of overpressure on Bottle B during filling the container while the container is hanging by the neck in a neck hang fill system according to some aspects of the present invention.

FIGS. 5a-5f illustrate Bottles A and B under increasing amounts of vacuum pressure experienced during the hot fill process.

FIG. 6 illustrates an example of a beverage container (“Bottle C”) according to some aspects of the present invention.

FIG. 7 illustrates the effect of overpressure on Bottle C during filling the container while the container is hanging by the neck in a neck hang fill system according to some aspects of the present invention.

FIG. 8 illustrates an example of a beverage container (“Bottle D”) according to some aspects of the present invention.

FIG. 9 illustrates the effect of overpressure on Bottle D during filling the container while the container is hanging by the neck in a neck hang fill system according to some aspects of the present invention.

FIG. 10 illustrates elongation under hot fill pressures for Bottles A-D.

FIG. 11 illustrates resistance to compression forces in the longitudinal axis of Bottles A-D.

FIGS. 12a-12f illustrate resistance to compression forces in the longitudinal axis of Bottles C and B.

FIG. 13 illustrates resistance to ovalization under hot fill vacuum conditions for Bottles A-D.

### DETAILED DESCRIPTION OF PREFERRED EMBODIMENTS

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Beverage containers for storing various types of beverages may be composed of a plastic material, such as polyethylene terephthalate (PET), among others. Such plastic beverage containers often have a generally cylindrical construction. Plastic beverage containers may be filled with a beverage via a hot-filling operation. In a hot-filling operation, a beverage to be stored in the beverage container is heated to an elevated temperature, such as a temperature of about 170 degrees Fahrenheit or more, and deposited in the beverage container. The beverage container may be supported on a support surface during filling, or the beverage container may be suspended by an upper end, or neck, of the beverage container during filling. Once filled and capped, the beverage container and beverage therein are rapidly cooled. This cooling of the beverage may result in thermal contraction, which reduces the internal volume of the beverage container. To accommodate the resulting pressure differential, side walls of the beverage container may be pulled inward. Depending on the structure of the beverage container, including its sidewall, this can result in undesirable deformation, or “paneling” of the side wall, where a once-cylindrical sidewall takes on flattened or otherwise deformed shapes in order to accommodate the internal vacuum created by the reduction in volume of the beverage due to thermal contraction during cooling.

To help the beverage container to maintain its cylindrical shape throughout the process of filling the beverage container with a liquid and subsequently during storage and transportation of the beverage container, one or more ribs may be formed in the beverage container. The ribs may be formed on the beverage container as recessed (indented) channels that extend toward an interior volume of the beverage container and extend completely around the circumference of the beverage container in a plane transverse to a longitudinal axis of the beverage container. The ribs help to prevent the beverage container from paneling or otherwise deforming when an internal pressure of the beverage container is less than an external pressure. Such paneling may reduce the structural stability of the beverage container. Also, beverage containers that experience deformation may be unappealing to consumers, which may negatively impact sales of the beverage containers. While the ribs extending around a circumference of the beverage container may help to avoid paneling, the ribs may make the beverage container more susceptible to elongation in a longitudinal direction during certain types of filling operations.

As the beverage container is composed of plastic, the plastic may begin to deform if heated to a sufficiently high temperature, such as a temperature at or above the glass transition temperature of the beverage container. As a result, when the beverage container is suspended from its upper end or neck and is filled with a high temperature beverage, the weight of the beverage within the container and the heat may cause the beverage container to elongate in a longitudinal direction. Specifically, elongation may be most significant at the ribs of the beverage container, as the ribs may stretch or flatten, resulting in elongation of the beverage container.

Elongation of the beverage container may be undesirable because the elongation may result in beverage containers having different heights. Beverage containers having various heights may make it difficult to stack and store the beverage containers. For example, a case of beverage containers having varying heights may not evenly carry the load of another case of beverage containers stacked atop the first. The taller beverage containers may carry more of the load than the shorter ones and may apply uneven pressure to the second case. This may make the second case sit unevenly on the first, making stacking and storage more difficult. This problem may compound as additional cases of beverage containers are stacked on top of one another.

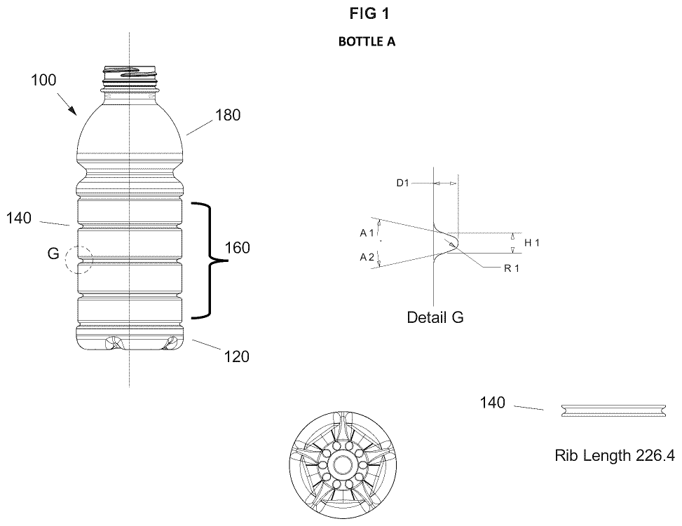

As shown, for example, in FIG. 1, a beverage container 100 (“Bottle A”) includes a base 120, a sidewall 160 extending from and integrally formed with base 120, and an upper region 180 extending from and integrally formed with sidewall 160 and defining an upper opening. Beverage container 100 includes a longitudinal axis Z extending centrally in a direction from base 120 to upper region 180. Sidewall 160 is generally cylindrical such that beverage container 100 has a generally circular transverse cross section (not accounting for channels formed in sidewall 160).

One or more horizontal channels 140 are formed in sidewall 160 that serve to prevent or limit radial deformation of beverage container 100 in a direction perpendicular to the longitudinal axis Z. Channels 140 are formed as recessed areas in sidewall 160 that extend toward an interior volume of beverage container 100. Channels 140 serve to resist paneling of sidewall 160 (e.g., when an internal pressure of beverage container 100 is less than an external pressure) by contributing hoop strength to beverage container 100. Specifically, beverage container 100 is additionally configured to resist a certain amount of elongation in a direction of longitudinal axis Z when beverage container 100 is suspended from upper region 180 and is filled with a beverage having a temperature at or above a glass transition temperature of the material forming beverage container 100 (e.g., PET).

The amount of resistance to elongation in the longitudinal direction is governed by the configuration of the channels. In container 100 the horizontal channels have a certain depth inward into the body portion (D1), a certain radius (R1) defining the inner portion of the channel, a certain height of the channel (H1), an angle joining the inner annular radius R1 to the sidewall portion above the channel (A1) and an angle joining the inner annular radius R1 to the sidewall portion below the channel (A2).

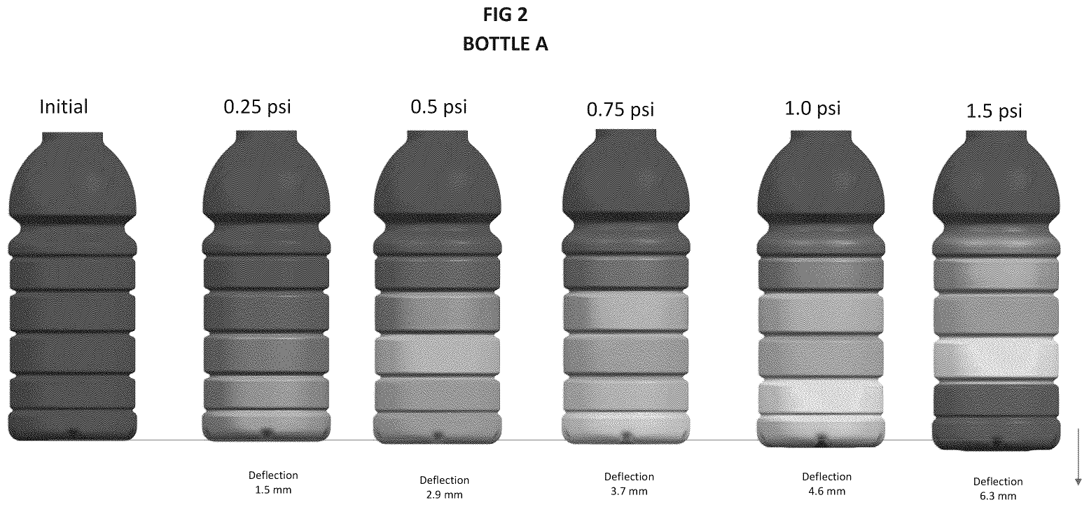

With reference to FIG. 2, container 100—“Bottle A”—is subjected to varying amounts of stress under Finite Element Analysis to show the effect of overpressure during filling the container while the container is hanging by the neck in a neck hang fill system. As the effective pressure increases Bottle A increases in overall height in the longitudinal direction.

To increase the amount of resistance to elongation in the longitudinal direction, according to at least one embodiment of the present invention, the channels may however be configured in a substantially different manner.

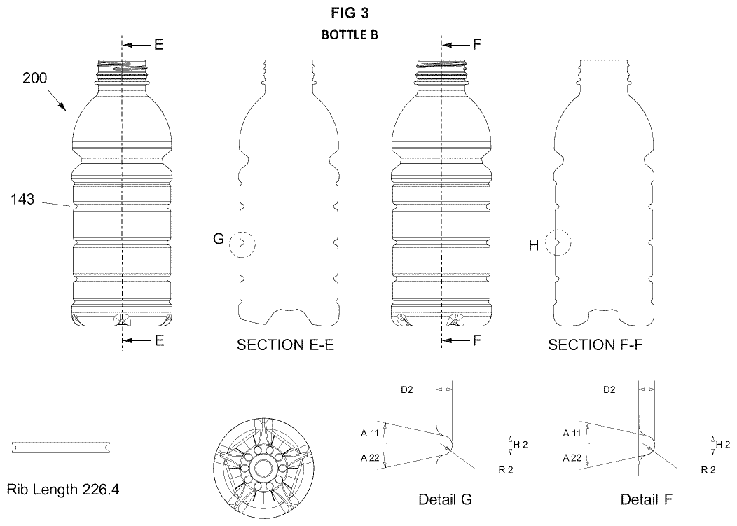

With reference to FIG. 3, the amount of resistance to elongation in the longitudinal direction is increased by the changed configuration of the channels 143. In container 200 the horizontal channels 143 have a lesser depth inward into the body portion (D2), and a larger radius (R2) defining the inner portion of the channel. Additional configurations to increase resistance to elongation may include increasing the height of the channel (H2) by increasing the angles joining the inner annular radius R2 to the sidewall portion above the channel (A11) and an angle joining the inner annular radius R2 to the sidewall portion below the channel (A22).

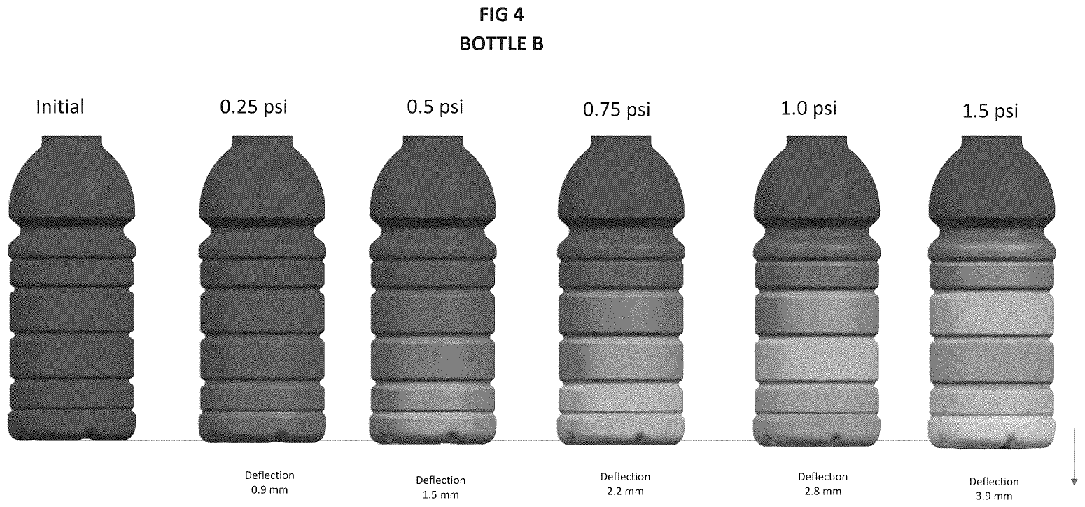

With reference to FIG. 4, container 200 is subjected to the same varying amounts of stress under Finite Element Analysis to show the effect of overpressure during filling the container while the container is hanging by the neck in a neck hang fill system. As the effective pressure increases Bottle B increases in overall height in the longitudinal direction.

Importantly, the amount of elongation in the longitudinal direction of Bottle B is decreased when compared to Bottle A due to the configuration changes in the respective channels.

A problem exists, however with such reductions in depth of horizontal annular grooves during hot fill processing. As the grooves are configured to reduce elongation, for example by reducing the depth D of the groove, the hoop strength of the grooves, channels or annular ribs may also reduce. As the hot liquid is cooled within a sealed container and a vacuum pressure force increase within the container, the container with the decreased elongation characteristics may experience problems maintaining shape and begin deforming or ovalizing while in distribution or in the consumer hands.

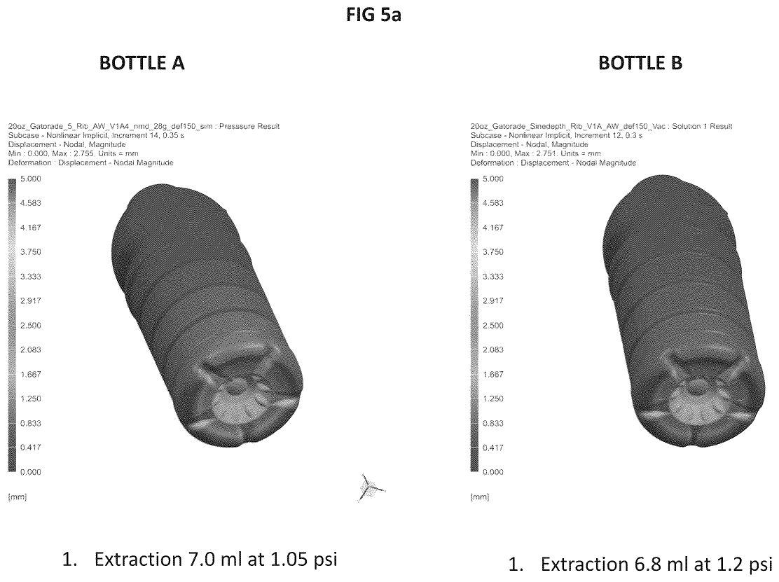

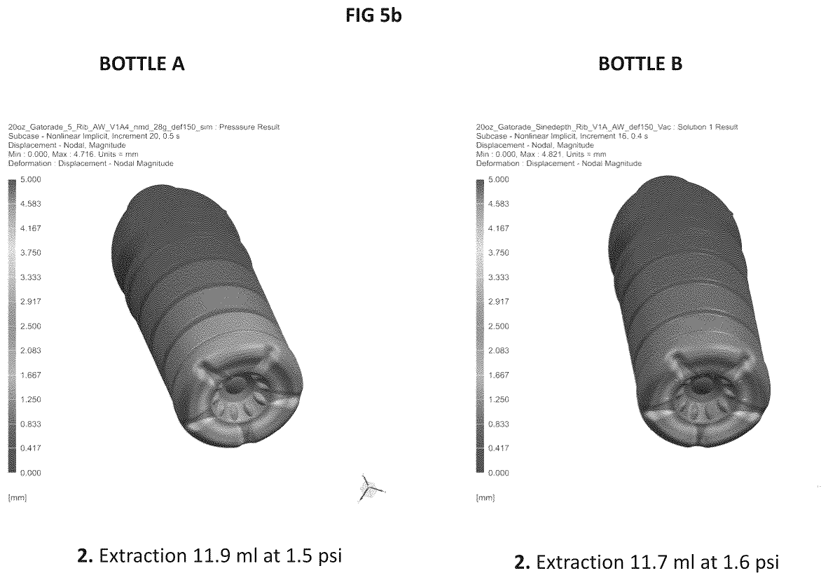

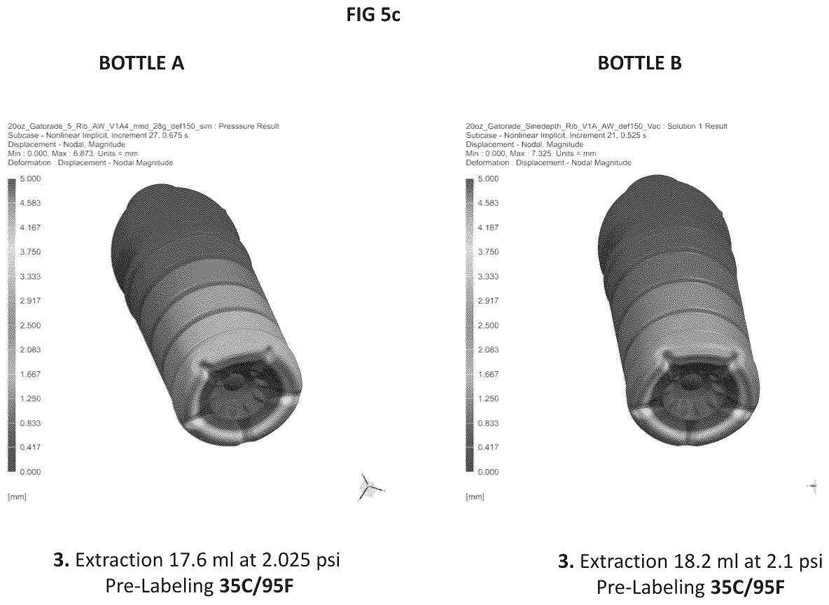

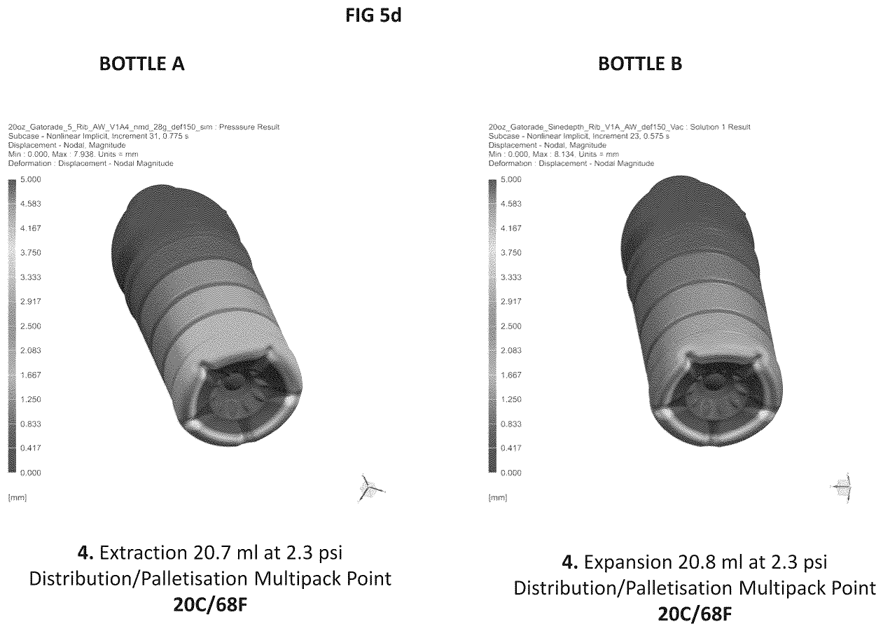

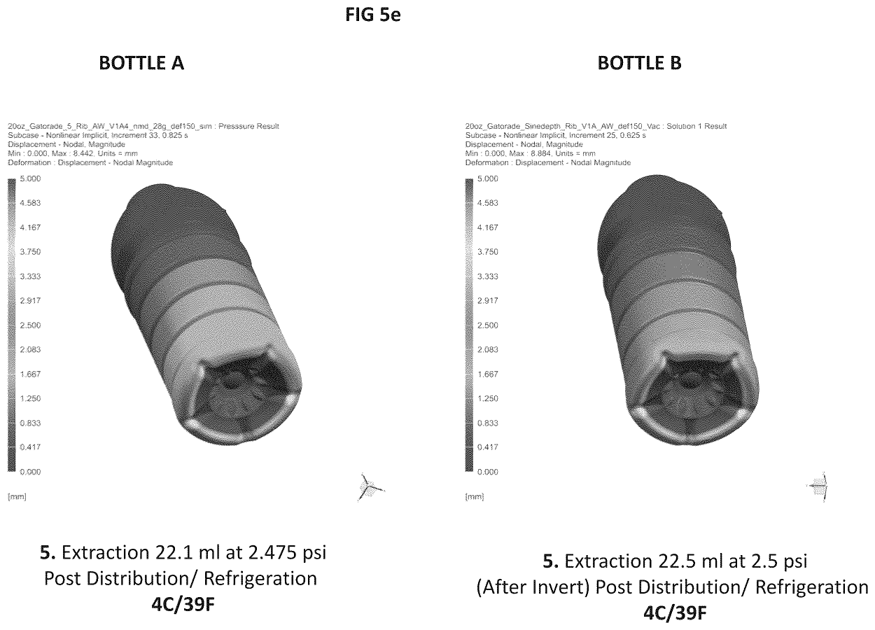

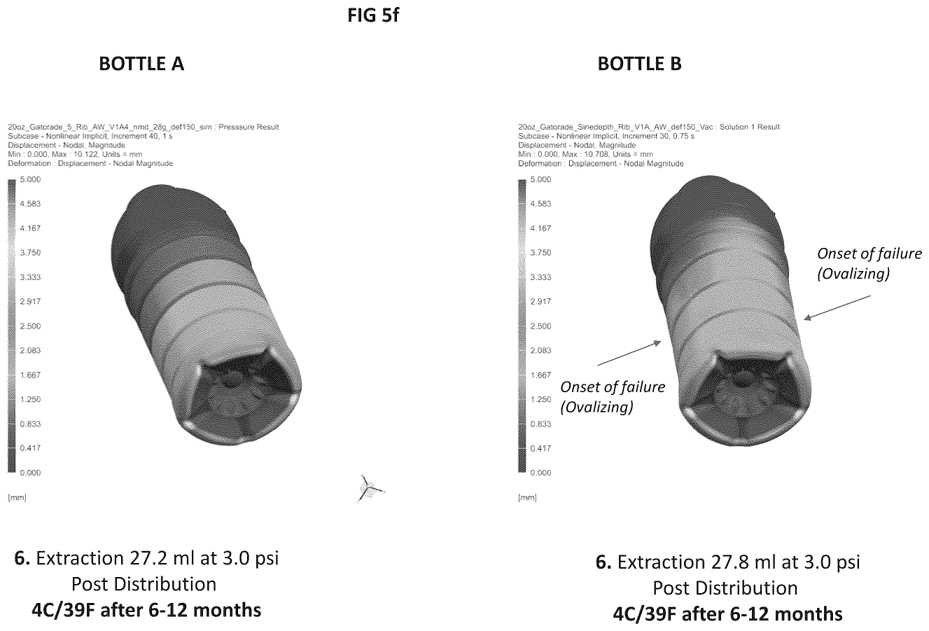

FIGS. 5a-5f show Bottles A and B under increasing amounts of vacuum pressure experienced during the hot fill process. Bottles are required to experience a level of vacuum pressure at least to the level shown in FIG. 5f, approximating a shelf life of 6 months duration and allowing for a certain amount of water vapor transmission through the sidewalls. As is shown in FIG. 5f, Bottle B which has a decreased amount of elongation under hot fill processing but also begins to ovalize and deform unacceptably prior to the expected length of shelf life due to the annular channels being less deep for example that Bottle A.

As disclosed in U.S. Pat. No. 6,779,673 (hereinafter referred to as '673), incorporated in its entirety herein, a container having an inverted active cage may include a body portion having a central longitudinal axis, a periphery, a plurality of active surfaces, and a network of pillars.

In one embodiment of the present invention, each of the plurality of active surfaces disclosed in '673 may be replaced by a plurality of non-active surfaces that are configured to provide greater label surface presentation in the sidewall during label application. Each non-active surface is outwardly displaced with respect to the longitudinal axis, while each of the network of pillars is inwardly displaced with respect to the longitudinal axis. The plurality of non-active surfaces, together with the network of pillars, are spaced about the periphery for accommodating vacuum-induced volumetric shrinkage of the liquid contents of the container resulting from a hot-filling, capping and cooling thereof.

The body portion may suitably comprise a hollow body formed generally in the shape of a cylinder. As a result, a cross-section of that body in a plane perpendicular to the longitudinal axis may comprise a circle, an ellipse, or an oval.

Alternatively, the body portion may suitably comprise a hollow body formed generally in the shape of a polyhedron (i.e., a solid bounded by planar polygons). In those instances where the body portion is formed generally in the shape of a polyhedron, such shape may more specifically be a parallelepiped (i.e., a polyhedron all of whose faces are parallelograms).

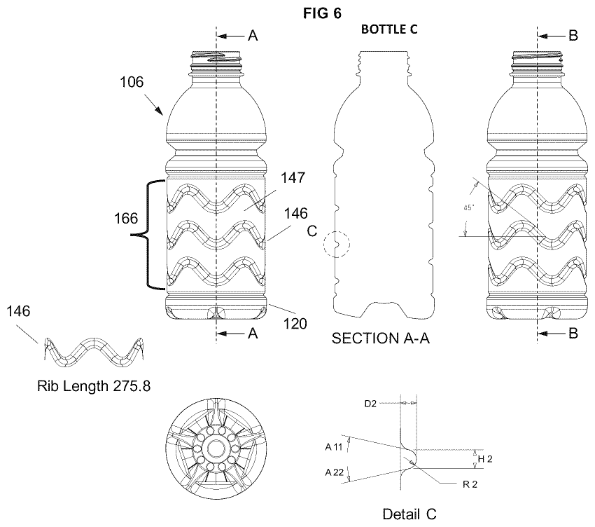

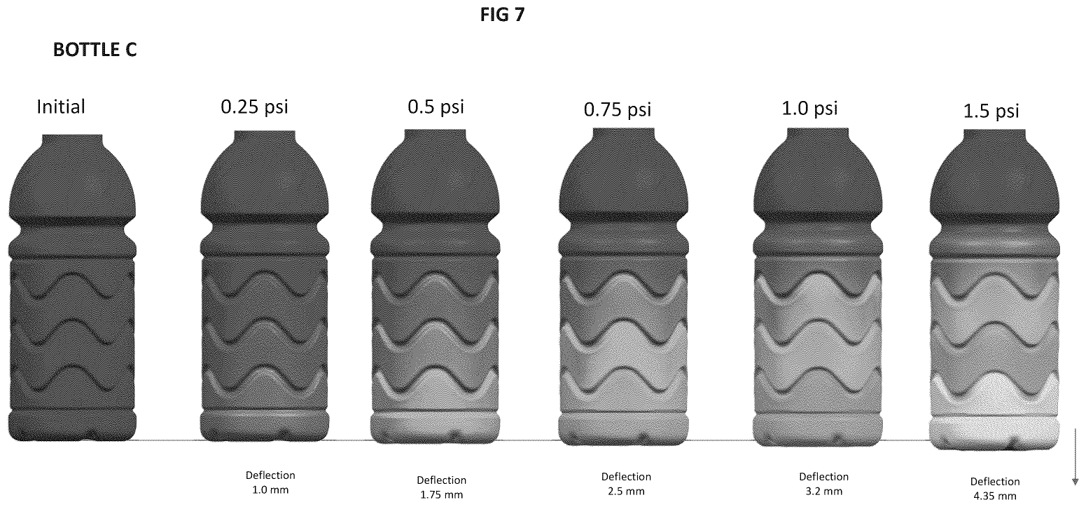

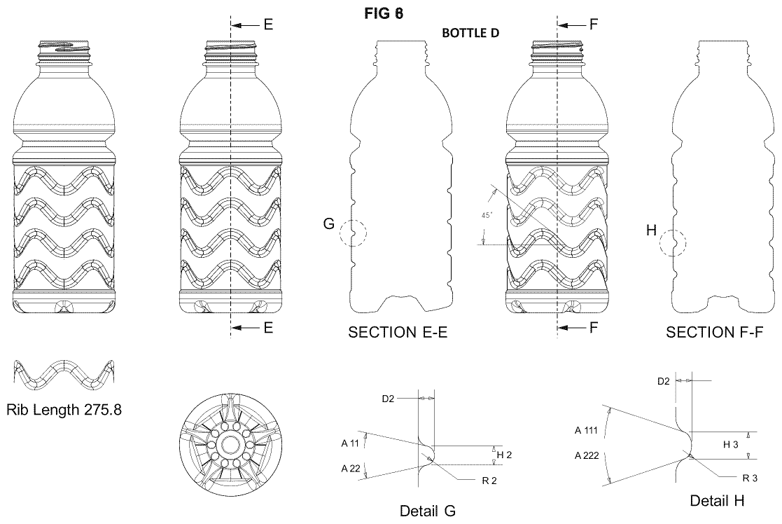

With reference to FIG. 6, according to one aspect of the present invention, there is provided a container 106 having a rigidified label panel portion in the sidewall 166. As a result, vacuum absorption occurs in a controlled manner in response to changing container pressure. Each of the plurality of non-active surfaces 147 are rigidified against deformation under vacuum, and collectively comprise a controlled non-deflection label application panel or vacuum resistant panel.

The network of pillars of the present invention preferably comprises one or more grooves 146 separating each of the plurality of non-active surfaces 147. Each groove may extend substantially between the top portion and the base portion. In one embodiment, a top portion of each groove is displaced from a bottom portion thereof by approximately between 40 and 60 degrees around the periphery of the container.

In the embodiment disclosed in FIG. 6, the network of pillars comprises three substantially sinusoidal-shaped grooves 146 extending about the periphery of the container. The grooves extend substantially between the top portion and the base portion.

In the embodiment shown in FIG. 6, Bottle C has a network of pillars that each comprise an annulus wherein a top portion of each groove is displaced from a bottom portion thereof by approximately 45 degrees around the periphery of the container. The annulus as measured in the vertical section A is shown in Detail C having identical characteristics to the annulus or groove described in FIG. 3 or Bottle B (when measured along the points of the annulus that are horizontally aligned. In this embodiment of the present invention, however, each annulus comprises a substantially sinusoidal-shaped groove extending about the periphery of the container. Importantly, the sinusoidal configuration provides additional length to the annulus or groove or rib. This increased length of the annular rib increases the amount of rigidity provided to the sidewall, and spreads the rigidity over a greater portion of vertical height of the sidewall. However, the elongation experienced under hot-filling while neck hanging is however increased, due in part to the increased length of the ribs providing even greater potential for separation of each rigidified non-active surface between the three sinusoidal channels.

As shown in FIG. 7 the elongation of Bottle C is greater than the elongation of Bottle B under the same conditions as experienced during the neck hanging hot fill cycle.

As shown in FIG. 8, another embodiment of the present invention is disclosed wherein Bottle D has the same construction to Bottle C but comprises four sinusoidal channels instead of the configuration of Bottle C having three sinusoidal channels and two smaller horizontal channels.

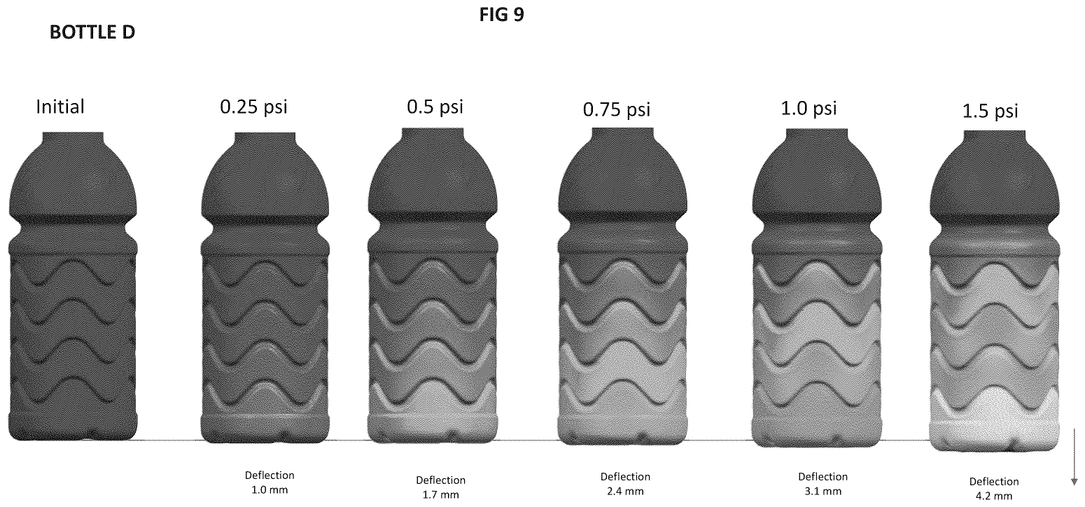

As shown in FIG. 9, Bottle D experiences less elongation than Bottle C under the same hot fill conditions. However, Bottle D experiences greater elongation under the hot fill neck hanging conditions that Bottle B.

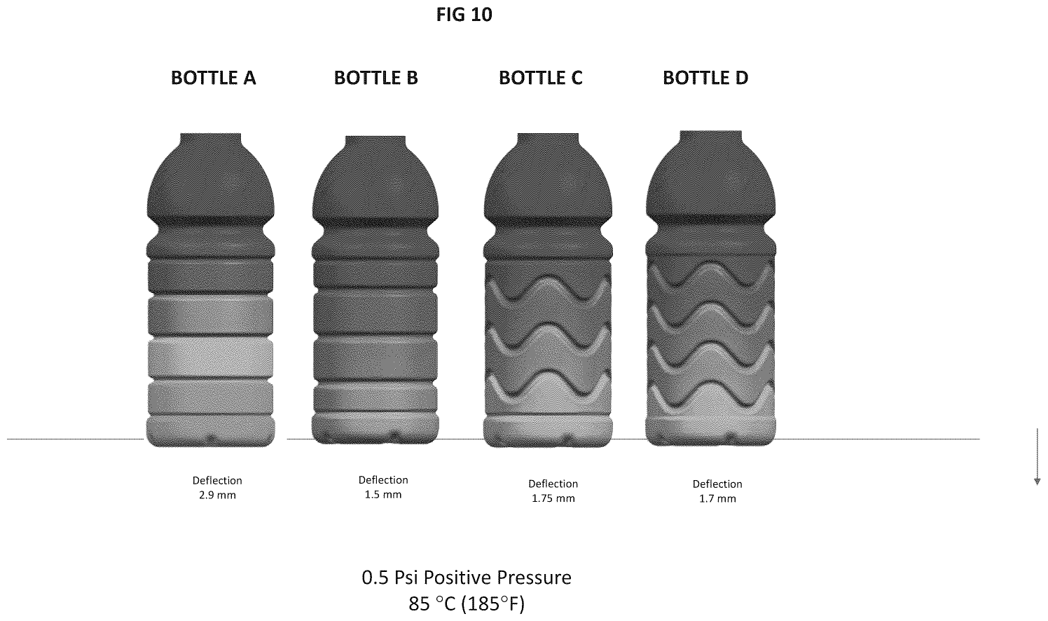

As shown in summary in FIG. 10, the increased length of the annular channels provided by the sinusoidal configuration in both Bottles C and D result in an increased elongation under hot fill pressures than Bottle B which has the same rib depth and annulus radius.

Therefore, in one embodiment of the present invention described herein, a beverage container includes a sidewall with multiple channels formed in the sidewall each having a sinusoidal shape that extends around a circumference of the beverage container. The channels help to increase elongation of the beverage container, such as during hot-filling operations, while also providing resistance to vacuum panelling by reinforcing the non-active surfaces between each channel. The sidewall of the beverage container may further include linear or horizontal channels or channel segments that extend along a portion or all of a circumference of the sidewall. The linear channels may provide further resistance to panelling.

However, the continuous channels 146 of the present invention serve a triple purpose: (1) to control elongation of the sidewall (2) to provide hoop strength and provide rigidity and strength to the bottle when being grasped by a consumer—and also resist vacuum deformation or prevent panelling of beverage container 106 when an internal pressure of beverage container 106 is less than an external pressure, and (3) to resist or prevent compression of beverage container 106 in a direction of longitudinal axis A under top load during hot-filling operations.

As discussed, ribs (or channels) that extend circumferentially around the beverage container and that are oriented in or near a sinusoidal configuration may be more susceptible to elongation in the direction of longitudinal axis A, because, for example, the weight of a high-temperature beverage will be directed in the direction of longitudinal axis A, nearly perpendicularly to the ribs at each peak or trough of the channel.

However, diagonal regions of continuous channel 146 are less susceptible to compression under top load, as experienced for example during base support filling where there is little neck support for the container to prevent a load being applied downwardly in the longitudinal direction. The diagonal regions of the sinusoidal channels are oriented at an angle relative to a transverse plane, and the configuration of the channel in the diagonal regions of the present invention provide steeper angles joining the innermost portion of the channel annulus to either, or both, the upper portion or lower portion of the adjacent sidewall.

As shown in FIG. 6b, the channel comprises a different configuration than is found in Bottle B. As shown in the vertical section through a diagonal portion of the channel, in the present embodiment, which is not intended to be limiting, the radius R3 is larger than radius R2 (measured through a peak or trough) and the angles A111 and A222 are steeper than respective angles A11 and A22. As a result, when beverage container 106 is filled with a high-temperature beverage, beverage container 106 is less able to compress longitudinally in the diagonal region of continuous channel 146. The weight of the top load (in the direction of longitudinal axis A) will not be perpendicular to the direction of diagonal region, and importantly the diagonal region has a configuration of equal depth to each peak or trough, but with greater radius and angular entry and exit from the sidewalls to the depth of the annular channel, and the longitudinal down force will also instead be at an angle thereto.

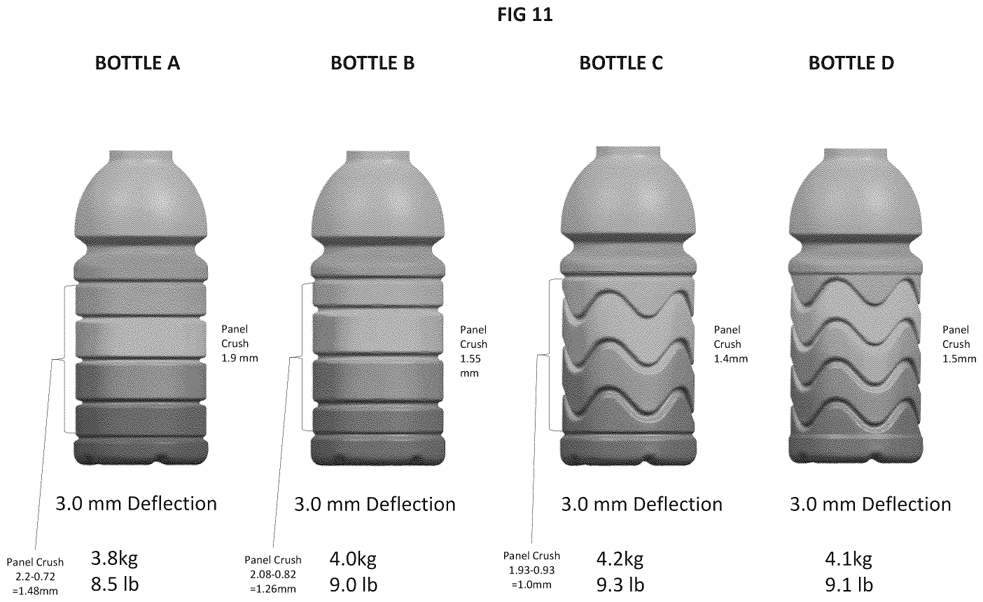

With reference to FIG. 11, the sinusoidal channel configurations of the present invention in Bottles C and D provide increased resistance to compression forces in the longitudinal axis than are exhibited in Bottles A or B.

More importantly, the sinusoidal channel configurations of the present invention in Bottles C and D provide increased resistance to vacuum deformation and prevent panelling of beverage container 106 when an internal pressure of beverage container 106 is less than an external pressure than is provided for in Bottle B.

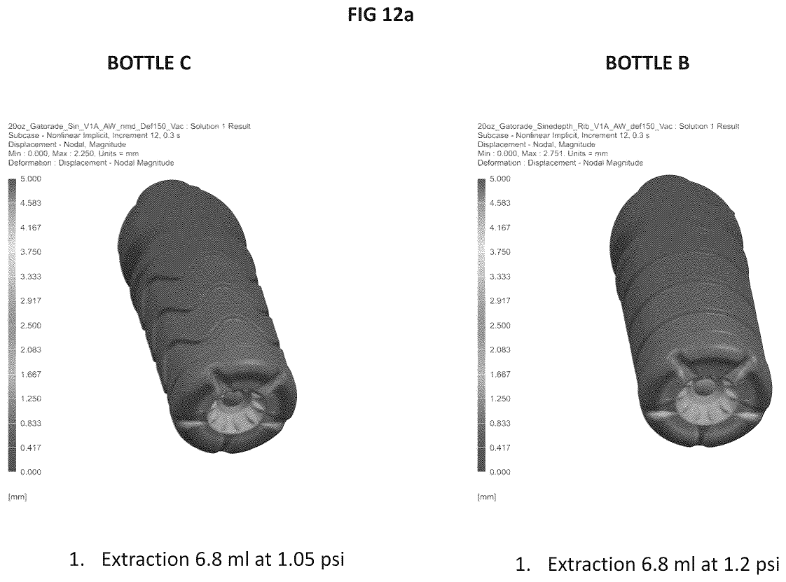

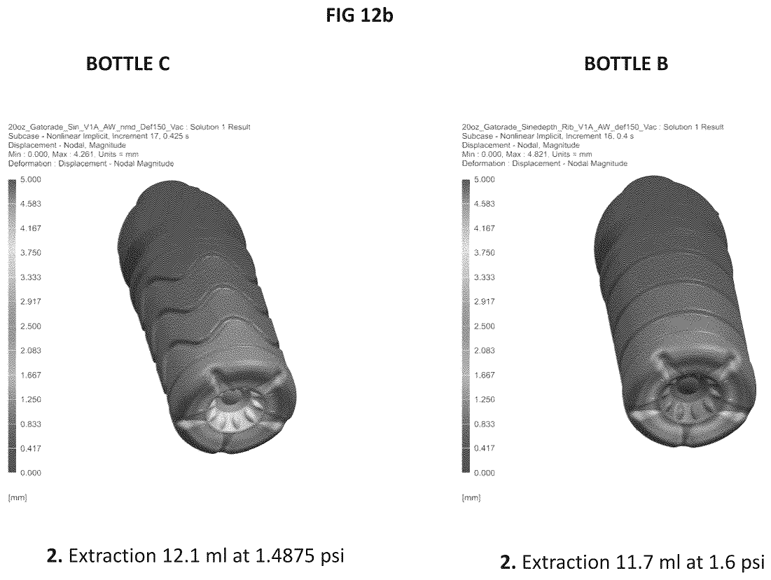

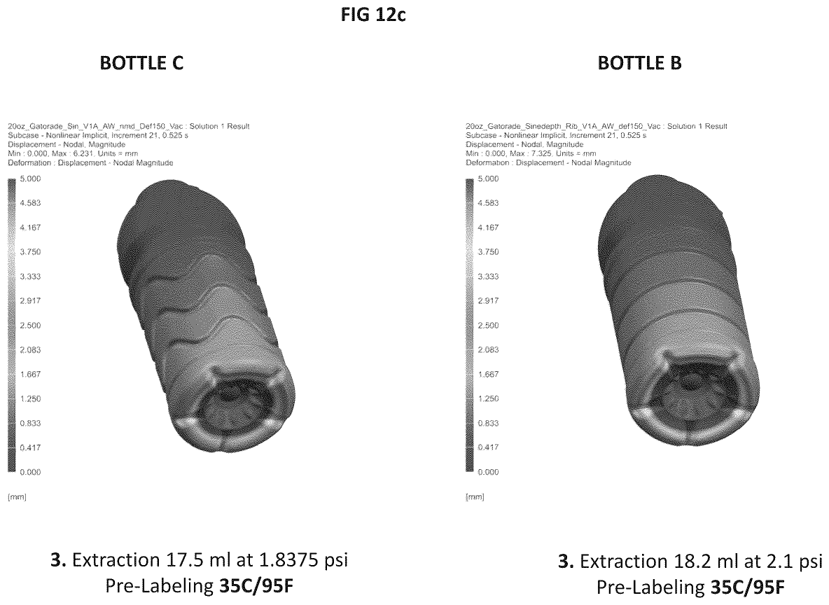

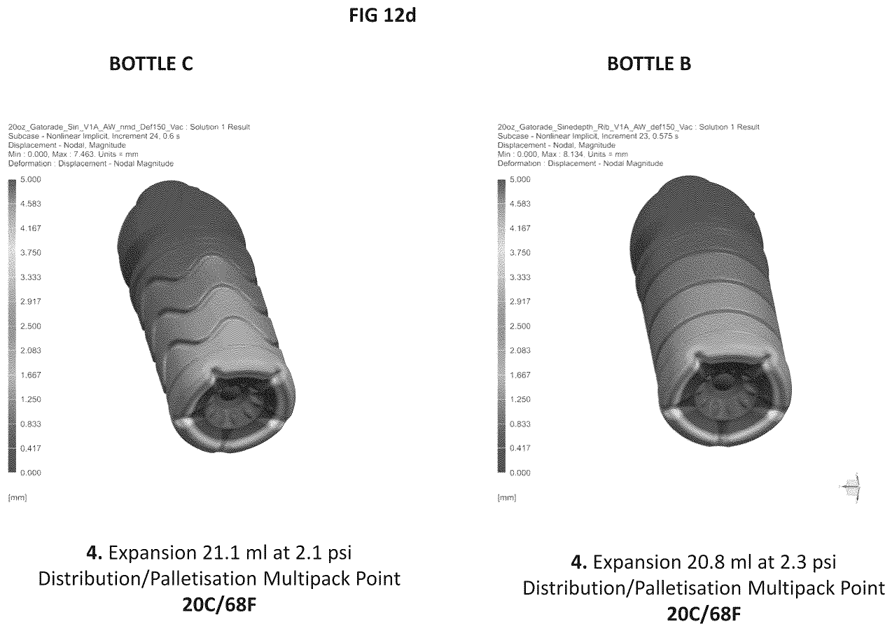

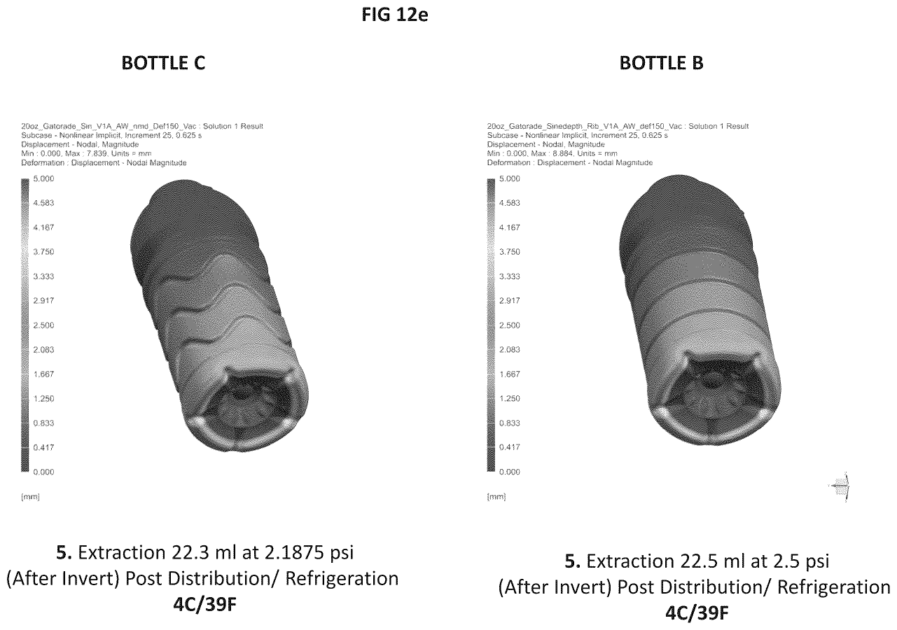

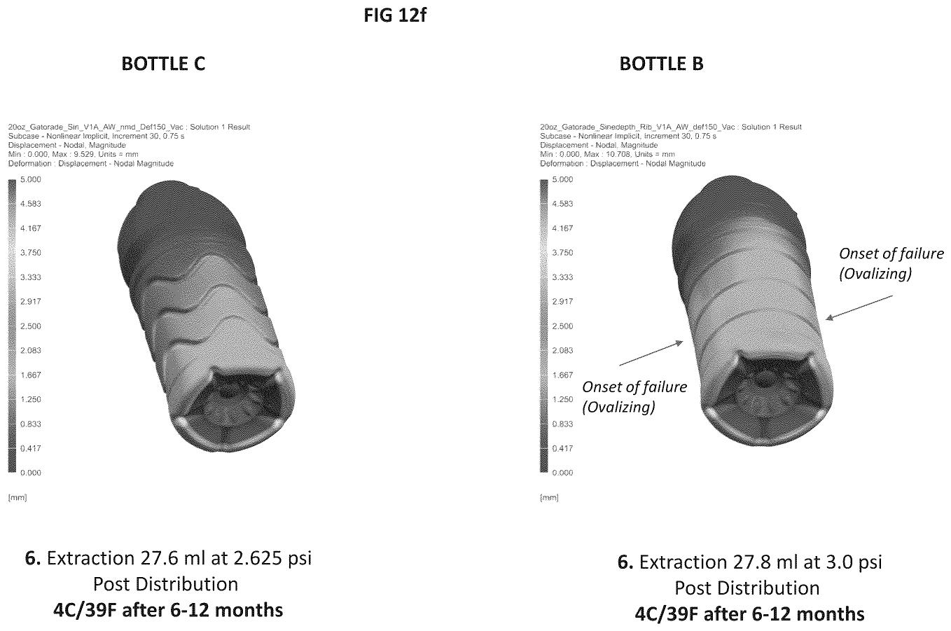

With reference to FIGS. 12a-12f, the sinusoidal channel configurations of the present invention in Bottles C provides increased resistance to compression forces in the longitudinal axis than is exhibited in Bottle B. As previously discussed, Bottle B fails and ovalizes unacceptably early and would not survive distribution requirements, whereas Bottle C is configured to prevent ovalization and lower the vacuum pressure experienced in the container, thus being superior to Bottle B. Additionally, as previously disclosed, the sinusoidal channels of Bottle C exhibit greater top load and resistance to compression in the longitudinal axis than Bottle B configurations.

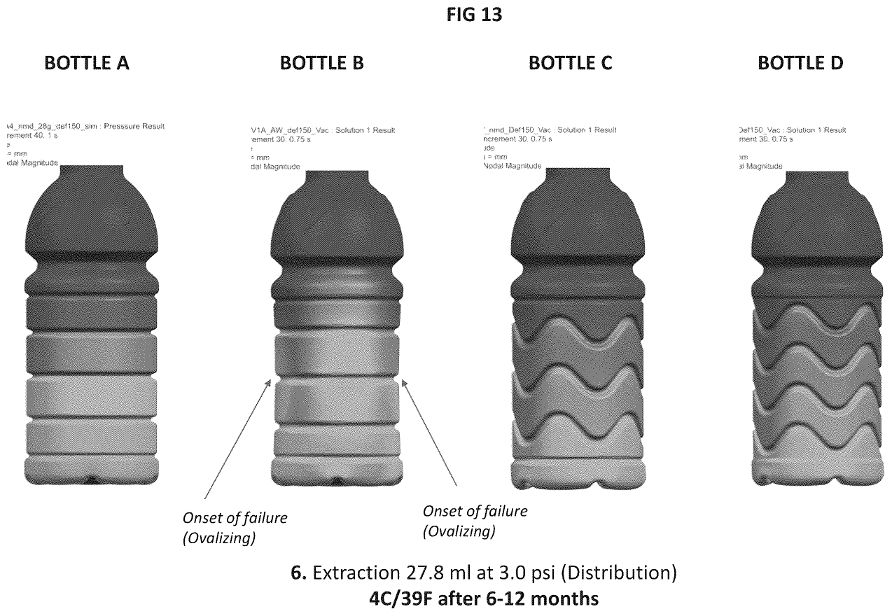

As shown in FIG. 13, for a sidewall to provide the required hoop strength and resistance to ovalization under hot fill vacuum conditions, the ribs must either be deeper as provided for in the horizontally aligned ribs of Bottle A, or may only be reduced in depth (as provided for in Bottles B, C and D) if configured as in the sinusoidal manner of Bottles C and D and disclosed above.

Therefore, with the additional configuration benefits of the present invention, the sidewall configuration of Bottle C also outperforms the sidewall configuration of Bottle A, by exhibiting less elongation through the use of the advantageously designed sinusoidal channels than the horizontally aligned channels of Bottle A—seen with reference to FIGS. 2, 7 and 9.

It is a particular aim of the present invention, therefore, to provide a container having a high percentage of PCR, that provides greater strength and control against sidewall ovalization under hot fill vacuum deformation force through the addition of channels and ribbings configured in a sinusoidal manner as described herein.

It is a further particular aim of the present invention to provide such sinusoidal configurations in containers having greater than 25% PCR, or preferably more than 50%, 75% PCR, and to even provide for containers of such configurations having 100% PCR material in the sidewalls. As the percentage of PCR increases and reduces the strength and integrity of prior art sidewalls, the improved channel configurations provide a necessary increase in inherent strength to enable use of high PCR amounts.

It is yet another aim of the present invention to provide for improved configuration in sidewalls of containers, particularly those incorporating high percentages of PCR, through the use of sinusoidal shaped channels as described herein that limit the compression in the height of the container under top load. This beneficially provides for increased top load and reduces the internal pressure build-up experienced within a container that has been hot filled, sealed and subject to compression forces in pallet loads while being distributed or stored in layers ready for distribution.

It is yet another aim of the present invention to provide for improved configuration in sidewalls of containers, particularly those incorporating high percentages of PCR to provide for light-weighting of the sidewalls through the increased strength offered by the sinusoidal channels as herein described.

It is yet another aim of the present invention to provide sinusoidal channel configurations as herein described that allow for increased PCR content preferably above 25%, that increase top load values and reduce compression of the container under hot vented situations and hot filled and sealed situations, and reduce the amount of stretch that containers may experience during neck supported hot filling, and also reduce the amount of compression that containers may experience during base supported hot filling in order to reduce the differentials between container heights blow-molded to the same specifications but filled on different filling systems.

It is a further aim of the present invention to combine the sidewall structures disclosed herein with the vacuum base structures disclosed or incorporated within U.S. patent application Ser. Nos. 15/284,622, 16/304,942, 17/090,611, 17/260,475, and 17/423,353—all of which are incorporated herein in their entirety.

What is claimed is:

1. A beverage container, comprising:
a base;
a cylindrical sidewall extending from and integrally formed with the base;
an upper region extending from the cylindrical sidewall and defining an upper opening, wherein the beverage container comprises a longitudinal axis extending in a direction from the base to the upper opening; and,
at least one continuous channel formed in and extending around a circumference of the cylindrical sidewall, wherein the continuous channel is sinusoidal such that the continuous channel forms peaks and troughs, wherein the continuous channel comprises at least two different radii of curvatures measured in a vertical or longitudinal axis and is configured to resist longitudinal compression of the container under a top load force and to resist vacuum compression in the radial or transverse direction of the beverage container.

2. The container of claim 1, wherein the continuous channel comprises an amount of Post Consumer Resin (PCR) and is configured to have a different radius of curvature or height or depth of channel measured in the vertical or longitudinal axis through a peak or trough than measured through a diagonal portion of the channel.

3. The container of claim 1, wherein the continuous channel is configured to provide for a calculated amount of elongation in the longitudinal direction under an applied internal pressure.

4. The container of claim 3, wherein the container comprises about 25% PCR.

5. The container of claim 3, wherein the container comprises more than about 25% PCR.

6. The container of claim 3, wherein the container comprises three continuous channels.

7. The container of claim 1, wherein the container comprises four or more continuous channels.

8. A blow-molded plastic container, comprising:
an enclosed base portion;
a body portion extending upwardly from said base portion, said body portion including a central longitudinal axis, a periphery, a plurality of rigidified and non-active surfaces, and a network of rigidified channels or pillars; and,
a top portion with a finish extending upwardly from said body portion;
wherein, with respect to said longitudinal axis, each of said plurality of non-active surfaces is outwardly displaced and each of said network of pillars is inwardly displaced, and said plurality of non-active surfaces together with said network of pillars are spaced about said periphery for accommodating vacuum-induced volumetric shrinkage of the container resulting from a hot-filling, capping and cooling thereof, wherein said body portion comprises a hollow body formed generally in the shape of a cylinder and,
wherein the container and channels or pillars comprises more than 25% PCR,
wherein said channels or pillars include an annulus comprising a substantially sinusoidal-shaped groove extending about said periphery of the container, wherein at least one of the channels or pillars is configured to provide for an amount of elongation in the longitudinal direction under a positive internal pressure.

9. A blow-molded plastic container, comprising:
an enclosed base portion;
a body portion extending upwardly from said base portion, said body portion including a central longitudinal axis, a periphery, a plurality of non-active surfaces, and a network of channels or pillars; and,
a top portion with a finish extending upwardly from said body portion;
wherein, with respect to said longitudinal axis, each of said plurality of non-active surfaces is outwardly displaced and each of said network of channels or pillars is inwardly displaced, and said plurality of non-active surfaces together with said network of channels or pillars are spaced about said periphery for accommodating vacuum-induced volumetric shrinkage of the container resulting from a hot-filling, capping and cooling thereof and,
wherein said channels or pillars include an annulus comprising a substantially sinusoidal-shaped groove extending about said periphery of the container, wherein at least one of the channels or pillars comprises at least two different radii of curvatures measured in a vertical or longitudinal axis and is configured to provide a calculated amount of elongation in the longitudinal direction under an applied internal pressure and to resist longitudinal compression of the container under a top load.

10. The container according to claim 9, wherein said container comprises at least 25% PCR.

11. The container according to claim 10, wherein said container comprises more than 25% PCR.

12. The container according to claim 11, wherein said container comprises 50% PCR or more.

13. A method of processing a blow-molded plastic container, the container comprising:
an enclosed base portion;
a body portion extending upwardly from said base portion, said body portion including a central longitudinal axis, a periphery, a plurality of non-active surfaces, and a network of channels or pillars, wherein said network of pillars comprises a plurality of grooves positioned substantially parallel to and in the direction of said longitudinal axis within each of said plurality of non-active surfaces, and wherein said network of channels or pillars further comprises an annulus; and,
a top portion with a finish extending upwardly from said body portion;
wherein, with respect to said longitudinal axis, each of said plurality of non-active surfaces is outwardly displaced and each of said network of channels or pillars is inwardly displaced, and said plurality of non-active surfaces together with said network of channels or pillars are spaced about said periphery for accommodating vacuum-induced volumetric shrinkage of the container resulting from a hot-filling, capping and cooling thereof and,
wherein said annulus comprises a substantially sinusoidal-shaped groove extending about said periphery of the container having at least two different radii of curvatures measured in a vertical or longitudinal axis; the method comprising:
supporting the base of the container while filling the container,
applying a top load force to the container while filling the container with a heated liquid,
providing a resistance to vertical compression under the top load force through the sinusoidal-shaped groove during the filling of the container,
removing the top-load force and sealing the container with a cap after filling the container with the heated liquid;
creating a vacuum force within the container by cooling the sealed or capped container and the heated liquid; and
applying a label to the container under the vacuum force; and
providing resistance to vacuum forces in a radial direction during the application of the label through the sinusoidal-shaped groove.
